(19) United States
(12) Patent Application Publication
(10) Pub. No.: US 2009/0012819 A1
(43) Pub. Date: Jan. 8, 2009

(54) SYSTEMS AND METHODS FOR ELECTRONIC HOSPITAL FORM COMPLETION

(75) Inventors: Prakash Mahesh, Hoffman Estates, IL (US); Mark M. Morita, Arlington Heights, IL (US); Vijaykalyan Yeluri, Sunnyvale, CA (US); Denny Wingchung Lau, Redwood City, CA (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/923,398

(22) Filed: Oct. 24, 2007

Related U.S. Application Data
(60) Provisional application No. 60/867,062, filed on Nov. 22, 2006.

(51) Int. Cl. G06F 19/00; G06Q 50/00

(52) U.S. Cl. 705/3; 705/2

(57) ABSTRACT

Certain embodiments provide a portable, handheld electronic input device and method of use for completing an electronic clinical form and transmitting electronic clinical form data to an external system. The device includes an adaptable, insertable electronic form requesting information related to at least one of a patient and patient care. The device also includes an input mechanism for providing information to complete the electronic form at the portable electronic input device. The input mechanism includes a keyboard, voice recognition software, handwriting recognition software, a touchscreen and/or a stylus enabling a user to input, output, search for, and retrieve information via the device. The device further includes a communication port for transmitting the electronic form and information. The electronic form, in conjunction with the device, provides policy information to a user and guides a user in completing the form using at least one of audio guidance and visual guidance.

### BACKGROUND OF THE INVENTION

The present invention generally relates to filling out electronic hospital forms.

Healthcare has become centered around electronic data and records management. Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during an imaging scan of a patient, medical personnel may access patient information, such as the patient exam order, that are stored in a medical information system. Alternatively, medical personnel may enter new information, such as history, diagnostic, or treatment information, into a medical information system during an imaging scan.

When a patient walks into a hospital, administration is required to collect patient demographic information and create a personal profile for the patient. Information related to the patient is then associated with the profile. Each department associated with the patient is supposed to fill out forms for any kind of diagnostic information it acquires from the patient. Technologists must fill out forms prior to any scans. Nurses must fill out forms after diagnostic evaluation. Additionally, referring physicians have to complete requisition forms prior to requesting a scan.

Use of pre-printed forms that require the users to hand fill is very costly and inefficient. Healthcare administrators must collect all the forms and keep them together in the patient's file. Manual data entry also leads to critical errors. Changes cannot be made quickly and efficiently. Protecting and securing the critical patient information is not easy, as anyone can have access to those files and look up personal information.

Further, the only means of input to a pre-printed form is through use of a pen or pencil. Physically challenged and/or elderly patients sometimes have a difficult time holding the pen or writing on a paper. Some people have poor vision that inhibits them to read the contents of the documents they are asked to sign (for example, their rights and hospital privacy practice regulations).

### BRIEF SUMMARY OF THE INVENTION

Certain embodiments of the present invention provide methods and systems for mobile completion of electronic clinical forms.

Certain embodiments provide a portable electronic input device for completing an electronic clinical form and transmitting electronic clinical form data to an external system. The device includes an adaptable, insertable electronic form requesting information related to at least one of a patient and patient care. The device also includes an input mechanism for providing information to complete the electronic form at the portable electronic input device. The device further includes a communication port for transmitting the electronic form and information for storage in an electronic file.

Certain embodiments provide a method for exchanging information between a patient and a clinical information system through use of a portable electronic input device displaying and accepting input in an electronic form, the portable electronic input device including an input mechanism for providing information to complete the electronic form at the portable electronic input device and a communication port for transmitting information from completion of the electronic form to an external system. The method includes providing an adaptable, insertable electronic form for completion by a user related to at least one of a patient and patient care. The method also includes accepting input information for the electronic form at the portable electronic input device. The method further includes transferring the input information from the portable electronic input device to an external system.

Certain embodiments provide a portable, handheld electronic input device for completing an electronic clinical form and transmitting electronic clinical form data to an external system. The device includes an adaptable, insertable electronic form requesting information related to at least one of a patient and patient care. The device also includes an input mechanism for providing information to complete the electronic form at the portable electronic input device. The input mechanism includes at least one of a keyboard, voice recognition software, handwriting recognition software, a touchscreen and a stylus enabling a user to input, output, search for, and retrieve information via the device. The device further includes a communication port for transmitting the electronic form and information for storage in an electronic file. The electronic form, in conjunction with the device, provides policy information to a user and guides a user in completing the form using at least one of audio guidance and visual guidance.

### BRIEF DESCRIPTION OF SEVERAL VIEWS OF THE DRAWINGS

FIG. 1 illustrates an example of a device displaying an electronic form in accordance with an embodiment of the present invention.

FIG. 2 illustrates an electronic clinical input system used in accordance with an embodiment of the present invention.

FIG. 3 illustrates a flow diagram for a method for electronic form completion in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

As described above, filling out pre-printed clinical forms and managing and securing the data efficiently poses a problem in current clinical environments. In addition, the conventional mechanism to fill forms using a pen or pencil is not suitable for most patients.

Certain embodiments provide a solution for managing patient diagnosis and demographic information and also provide additional forms of input to interact with electronic forms.

In certain embodiments, an electronic version of clinical forms that capture patient demographic or diagnostic information are provided on a portable or handheld device, such as a tablet PC, that can be provided to clinical departments. Additionally, certain embodiments enable additional input mechanisms such as voice command and dictation and handwriting input analysis in addition to a conventional keyboard/touchscreen. Submitted forms from different departments may be stored in a centralized location for secure and more cost effective management, for example.

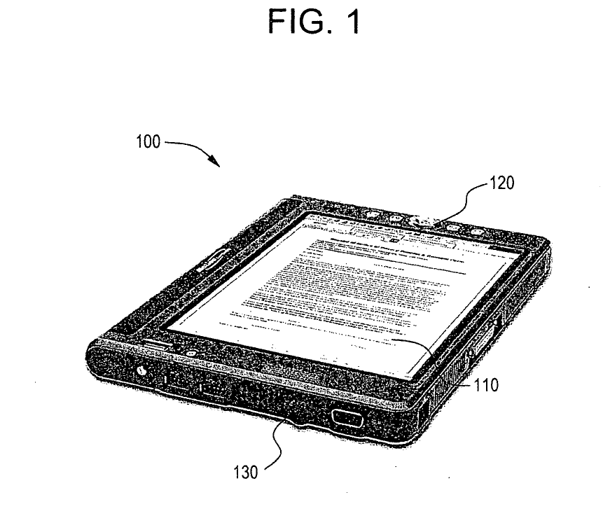

FIG. 1 illustrates an example of a device 100, such as a tablet personal computer (PC), pocket computer, personal digital assistant, or other handheld, with an electronic form 110 (an eform) displayed in accordance with an embodiment of the present invention. The device 100 includes content 110, such as an eform, one or more controls 120 to manipulate the content 110, and one or more connectors 130 providing input and/or output from the device 100 and an external system.

Eforms 110 may include one or more insurance forms, registration forms, admission forms, history forms, etc. In certain embodiments, the device 100 is configured with a particular form or set of forms. In certain embodiments, a user may select from a listing of forms, for example. In certain embodiments, forms 110 may be downloaded to the device 100 and/or a user may remotely request one or more forms 110 at the device 100 from one or more external systems, for example.

Control(s) 120 may include one or more buttons, keys, touch screen/pad, voice recognition, gesture/graffiti recognition, inputs, etc. Connector(s) 130 may include one or more universal serial bus (USB) ports, parallel ports, serial ports, headphone jacks, IEEE 1394 or FireWire ports, etc. Components of the device 100 may be implemented in software, hardware, and/or firmware, for example.

Controls 120 allow a user to provide input, search for information, request data retrieval, output information, etc. Controls 120, a stylus (not shown), a touchscreen, etc., may be used with the eform 110 to provide input of information and/or command, for example. Connectors 130 allow information and/or commands to be transmitted to and from the device 100 and one or more external systems, for example.

In operation, a user is provided with the device 100 at a clinical facility. An eform 110 is selected for display and completion at the device 100. Using one or more inputs 120, an eform 110 touchscreen, a stylus, etc., the user reviews and completes the eform 110 on the device 100. Once the eform 110 is completed, the data, including information and/or commands, for example, may be saved locally at the device 100, processed at the device 100, and/or transmitted to an external system, such as a printer, telephone, computer, database, etc., for storage, output and/or processing, for example.

Thus, a form 110 may be completed by a user at the device 100, transmitted to a practice management system via the connectors 130, and used in conjunction with a patient examination, for example. As another example, the eform 110 may be completed by a user using the device 100, transmitted to an electronic medical record system via the connectors 130, and stored as a new patient record and/or update of an existing patient record.

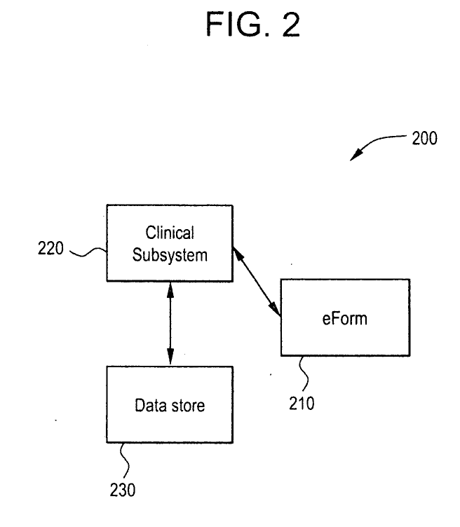

FIG. 2 illustrates an electronic clinical input system 200 used in accordance with an embodiment of the present invention. The system 200 includes a handheld electronic form (eform) 210, a clinical subsystem 220, and a database 230. The eform 210 may be implemented and function substantially as the eform 110 and device 100 described above with respect to FIG. 1, for example. Components of the system 200 may be implemented in software, hardware, and/or firmware, for example.

Information may be presented to a user via the eform 210. For example, the clinical subsystem 220 and/or database 230 may provide information for review and/or completion via the eform 210. Information entered via the eform 210 is transmitted to the clinical subsystem 220 for processing, output and/or storage at the clinical subsystem 220 and/or database 230.

For example, a user may review patient privacy and hospital policy information via the eform 210 and then sign in for a checkup at a hospital. Sign-in information is transferred from the form 210 to a practice management system to confirm the appointment and retrieve the patient's records from a database 230 or other electronic medical record system, for example. An examining physician may use the same or similar eform 210 device to enter observations and/or orders when examining the patient. The observations and/or orders are then transferred to an order entry system, a patient management system, an electronic medical record storage or other database 230, etc.

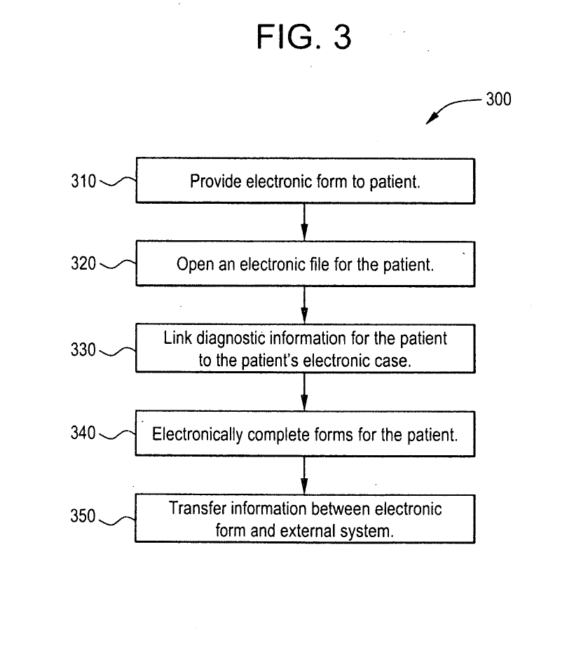

FIG. 3 illustrates a flow diagram for a method 300 for electronic form completion in accordance with an embodiment of the present invention. At step 310, a patient is provided with an electronic form. For example, a patient walks into a hospital. The administration provides him or her with an electronic form on a tablet pc that reads him his rights and the hospital privacy practices. He or she can electronically sign the form and/or complete any additional information in the form.

At step 320, an electronic file is opened for the patient. For example, an electronic medical record is created and/or updated for the patient. Information may be entered via the electronic form to populate and/or update information in the electronic medical record.

At step 330, diagnostic information for the patient is linked to the patient's electronic case. For example, based on identifying information associated with the patient and/or patient file, previously stored patient-related and/or reference diagnostic information may be associated with the patient file. Diagnostic information for the patient may help a physician and/or other clinician in further diagnosing and/or treating the patient. Similarly, reference diagnostic information may help a physician and/or other clinician in diagnosing and/or treating the patient.

At step 340, a clinician may electronically complete an order form for the patient. For example, in a case of an inpatient or outpatient examination, a referring physician who orders a scan can fill out an electronic form that will get linked to and saved with the patient's electronic file. The referring physician can fill out the form using voice dictation, using a stylus and a handwriting recognition utility, or both in conjunction with each other, for example. As another example, in a case of in-patients, nurses shall also be able to fill out patient evaluation information (e.g., nurse forms) electronically using voice dictation and/or handwriting recognition software.

At step 350, information may be transferred between the electronic form and an external system. For example, patient and/or clinician input may be transferred from the electronic form device to a patient or practice management system for storage, output, and/or processing. In certain embodiments, feedback and/or other information, such as query or processing results, may be provided from an external system to the handheld forms device.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In certain embodiments, patients are able to listen to hospital privacy practices and HIPAA forms which will be electronically read out to them and/or read information via the electronic forms device.

In certain embodiments, security may be provided to access, review and/or input information via the electronic forms handheld device. For example, password, passcode, and/or biometric (e.g., voice print, finger print, iris scan, etc.) identification may be used to authenticate access to the system.

In certain embodiments, a user is prompted or guided to complete information in an electronic form. For example, a user may be audibly guided through voice and/or other sounds to complete fields and/or other information and/or action in an electronic form. As another example, a user may be textually and/or graphically guided through words, icons, video, images, etc., to complete fields and/or other information and/or action in an electronic form.

In certain embodiments, different forms in various departments shall be provided on a tablet pc or other portable/handheld electronic device and shall have multiple input capabilities. Electronic forms shall be stored in a central location that is secure and protected.

Thus, certain embodiments provide a paper-less solution. Costs may be reduced by using less paper. Certain embodiments help improve efficiency. Electronic forms make it easier to save and retrieve information in a centralized location and organize it more effectively. Certain embodiments increase productivity. Since the electronic forms can be designed in an intuitive manner, a user may spend less time on correcting errors and understanding the questionnaire. Alternative input mechanisms provide high accuracy and low bandwidth for error. Certain embodiments provide security. Critical patient demographic and diagnostic information is saved securely on the hospital server. Sharing also happens securely without anyone getting access to the critical information.

Certain embodiments provide electronic forms and provide a user with the ability to interact with the forms via the regular keyboard, voice dictation, and/or handwriting recognition. This process is less prone to errors committed by the user when filling out paper forms using a pen or pencil. Storing all the patient forms in a central location will help increase efficiency of storage and retrieval of information and increase productivity of the hospital. Certain embodiments apply to a variety of forms in a hospital or other clinical environment that relate to a patient and help increase diagnostic value and cost effectiveness. Certain embodiments provide a technical effect of facilitating simplified, electronic form completion and exchange of information between users and electronic systems in a clinical environment.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A portable electronic input device for completing an electronic clinical form and transmitting electronic clinical form data to an external system, said device comprising:
an adaptable, insertable electronic form requesting information related to at least one of a patient and patient care;
an input mechanism for providing information to complete the electronic form at the portable electronic input device; and
a communication port for transmitting the electronic form and information for storage in an electronic file.

2. The device of claim 1, wherein said electronic input device comprises a handheld computing device.

3. The device of claim 1, wherein said input mechanism comprises at least one of a keyboard, voice recognition software, handwriting recognition software, a touchscreen and a stylus.

4. The device of claim 1, wherein said input mechanism includes security to authenticate a user of the device, said security including at least one of password verification, passcode verification, and biometric identification of the user.

5. The device of claim 1, further comprising a processor.

6. The device of claim 5, wherein said processor selects said electronic form from a plurality of stored electronic forms.

7. The device of claim 1, wherein said communication port communicates with a plurality of departmental information systems to transmit electronic form information.

8. The device of claim 1, wherein said input mechanism enables a user to input, output, search for, and retrieve information via the device.

9. The device of claim 1, wherein said electronic form guides a user in completing the form.

10. The device of claim 9, wherein said electronic form and said processor guide a user in completing the form using at least one of audio guidance and visual guidance.

11. A method for exchanging information between a patient and a clinical information system through use of a portable electronic input device displaying and accepting input in an electronic form, the portable electronic input device including an input mechanism for providing information to complete the electronic form at the portable electronic input device and a communication port for transmitting information from completion of the electronic form to an external system, said method comprising:
providing an adaptable, insertable electronic form for completion by a user related to at least one of a patient and patient care;
accepting input information for the electronic form at the portable electronic input device; and
transferring said input information from the portable electronic input device to an external system.

12. The method of claim 11, wherein said portable electronic input device comprises a handheld computing device.

13. The method of claim 11, wherein said accepting step further comprises accepting input information for the electronic form at the portable electronic input device via at least one of a keyboard, voice recognition software, handwriting recognition software, a touchscreen and a stylus.

14. The method of claim 11, further comprising authenticating a user of the portable electronic input device based on at least one of password verification, passcode verification, and biometric identification of the user.

15. The method of claim 11, further comprising selecting said electronic form from a plurality of stored electronic forms.

16. The method of claim 11, wherein said transferring step further comprises communicating with a plurality of departmental information systems to transmit electronic form information.

17. The method of claim 11, further comprising electronically guiding a user in completing the form via the portable electronic input device.

18. The method of claim 17, wherein said electronically guiding step further comprises electronically guiding a user in completing the electronic form using at least one of audio guidance and visual guidance.

17. The method of claim 11, further comprising enabling a user to input, output, search for, and retrieve information via the electronic form on the portable electronic input device.

18. A portable, handheld electronic input device for completing an electronic clinical form and transmitting electronic clinical form data to an external system, said device comprising:
an adaptable, insertable electronic form requesting information related to at least one of a patient and patient care;
an input mechanism for providing information to complete the electronic form at the portable electronic input device, said input mechanism including at least one of a keyboard, voice recognition software, handwriting recognition software, a touchscreen and a stylus enabling a user to input, output, search for, and retrieve information via the device; and
a communication port for transmitting the electronic form and information for storage in an electronic file,
wherein said electronic form, in conjunction with said device, provides policy information to a user and guides a user in completing the form using at least one of audio guidance and visual guidance.

19. The device of claim 18, further comprising a processor, said processor configured to select said electronic form from a plurality of stored electronic forms.

20. The device of claim 18, wherein said communication port communicates with a plurality of departmental information systems to transmit electronic form information.
